(19) United States
(12) Patent Application Publication
(10) Pub. No.: US 2026/0120035 A1
(43) Pub. Date: Apr. 30, 2026

(54) MANUFACTURING PLAN FORMULATION METHOD, MANUFACTURING PLAN FORMULATION SYSTEM, PROGRAM, INFORMATION TERMINAL

(71) Applicant: Panasonic Intellectual Property Management Co., Ltd., Osaka (JP)

(72) Inventor: Hideo UMETANI, Osaka (JP)

(21) Appl. No.: 19/429,165

(22) Filed: Dec. 22, 2025

Related U.S. Application Data
(63) Continuation of application No. PCT/JP2024/024405, filed on Jul. 5, 2024.

(30) Foreign Application Priority Data
Jul. 10, 2023 (JP) 2023-113185

(51) Int. Cl. G06Q 10/0637; G06Q 10/0631; G06Q 50/04

(52) U.S. Cl. CPC G06Q 10/0637; G06Q 10/06311; G06Q 50/04

(57) ABSTRACT

A manufacturing plan formulation method is a manufacturing plan formulation method performed by an arithmetic circuit for formulating a manufacturing plan for a product to be manufactured by a manufacturing process in which a plurality of actors perform tasks sequentially, and includes: identifying a first indicator value indicating a degree of replacement of the plurality of actors during a first period; identifying, based on the first indicator value, a change in proficiency of the plurality of actors from a start of the first period; and outputting a manufacturing plan of the product for the first period based on the change in proficiency.

### CROSS-REFERENCE TO RELATED APPLICATIONS

The present application is a continuation of PCT/JP2024/024405 filed Jul. 5, 2024, which claims the priority to Japanese Patent Application No. 2023-113185, filed on Jul. 10, 2023, the entire content of which is incorporated herein by reference.

### TECHNICAL FIELD

The present disclosure relates to manufacturing plan formulation methods, manufacturing plan formulation systems, programs, and information terminals.

### BACKGROUND ART

Patent Document 1 provides a method for estimating the tact time of each work process according to the product to be assembled and manufactured, taking into account common work elements among product types. In Patent Document 1, based on the actual performance data of work processes carried out on an assembly/manufacturing line to be handled by multiple workers, the work process is divided into work elements. For each work element, a learning curve of work elements, in which the working period corresponding to that element is determined, is prepared for each worker in advance. When a product to be assembled or manufactured on the assembly/manufacturing line is selected and the workers responsible for processing the work process are assigned, the working period corresponding to the planned cumulative number of work repetitions is calculated from the learning curve of work elements for each worker involved in that work process. The calculated working periods are then aggregated by product, and based on the aggregated time, predetermined calculations are performed to determine the tact time of the work process corresponding to the product to be assembled and manufactured.

### PRIOR ART DOCUMENTS

### Patent Documents

Patent Document 1: JP 4655494 B

### SUMMARY OF THE INVENTION

### Problems to be Solved by the Invention

In manufacturing sites such as factories, there exist processes in which work is performed manually, such as in craftsmanship and other production operations. In particular, in a line production system, multiple workers are permanently assigned to a single production line. In such cases, if one worker's task is delayed, the tasks of other workers are also delayed. The workers on the production line are not necessarily regular employees of the manufacturing company; they may also be temporary or part-time workers. When temporary or part-time workers are included among the production line workers, it is common for personnel changes to occur periodically (for example, every month). When a worker is inexperienced and has never performed the task before, a training period is provided. However, since such workers are naturally unfamiliar with the work, delays in their tasks are likely to occur. Therefore, when workers are replaced, there will inevitably be a learning loss until the new workers become proficient in the production line tasks.

In the technique described in Patent Document 1, by preparing a learning curve of work elements for each worker, it is possible to calculate the tact time (required time) of each work process according to the product to be assembled and manufactured. However, when a new and inexperienced worker joins the operation, it is not possible to prepare a learning curve of work elements for that worker, making it difficult to accurately determine the required time for the work process. As a result, even if a production plan is established based on such an estimated process time, its feasibility tends to be low.

The present disclosure provides a manufacturing plan formulation method, a manufacturing plan formulation system, a program, and an information terminal which enable improvement in feasibility of a manufacturing plan.

### Solutions to the Problems

A manufacturing plan formulation method according to one aspect of the present disclosure is performed by an arithmetic circuit for formulating a manufacturing plan for a product to be manufactured by a manufacturing process in which a plurality of actors perform tasks sequentially, and includes: identifying a first indicator value indicating a degree of replacement of the plurality of actors during a first period; identifying, based on the first indicator value, a change in proficiency of the plurality of actors from a start of the first period; and outputting a manufacturing plan of the product for the first period based on the change in proficiency.

A manufacturing plan formulation system according to one aspect of the present disclosure is a manufacturing plan formulation system for formulating a manufacturing plan for a product to be manufactured by a manufacturing process in which a plurality of actors perform tasks sequentially, and includes a first arithmetic circuit. The first arithmetic circuit is configured to: identify a first indicator value indicating a degree of replacement of the plurality of actors during a first period; identify, based on the first indicator value, a change in proficiency of the plurality of actors from a start of the first period; and output a manufacturing plan of the product for the first period based on the change in proficiency.

A program according to one aspect of the present disclosure is a program for enabling the above manufacturing plan formulation method to be performed by the arithmetic circuit.

An information terminal according to one aspect of the present disclosure is an information terminal to be communicably connected to the above manufacturing plan formulation system and includes: an input device; an output device; a communication device; and a second arithmetic circuit configured to control the input device, the output device, and the communication device. The second arithmetic circuit is configured to: receive, by the input device, input of the first indicator value; send, by the communication device, the first indicator value to the manufacturing plan formulation system to receive the manufacturing plan from the manufacturing plan formulation system; and present, by the output device, the manufacturing plan.

### Effects of the Invention

Aspect of the present disclosure enables improvement in feasibility of a manufacturing plan.

### BRIEF DESCRIPTION OF THE DRAWINGS

FIG. 1 is a schematic diagram of a manufacturing system according to one embodiment.

FIG. 2 is a schematic diagram of a manufacturing facility of the manufacturing system according to the above embodiment.

FIG. 3 is a block diagram of a manufacturing plan formulation system of the manufacturing system according to the above embodiment.

FIG. 4 is a block diagram of an information terminal of the manufacturing system according to the above embodiment.

FIG. 5 is a flowchart of a manufacturing plan formulation method performed by the manufacturing plan formulation system.

FIG. 6 is a graph showing time-series data of required time.

FIG. 7 is a graph showing a first example of a change in proficiency.

FIG. 8 is a graph showing a second example of a change in proficiency.

FIG. 9 is a bar graph showing a production quantity per unit period according to the manufacturing plan.

FIG. 10 is a bar graph showing a working period per unit period according to the manufacturing plan.

### DETAILED DESCRIPTION

### 1. Embodiments

Hereinafter, embodiments of the present disclosure will be described with reference to the drawings where appropriate. However, the following embodiments are merely examples for explaining the present disclosure, and are not intended to limit the present disclosure to the following content (e.g., shapes, dimensions, arrangement and the like, of components). Positional relationships such as up, down, left, and right are based on the positional relationships shown in the drawings, unless otherwise specified. Each figure described in the following embodiments is a schematic diagram, and the ratios of size and thickness of each component in each figure do not necessarily reflect the actual dimensional ratios. Furthermore, the dimensional ratios of each element are not limited to the ratios shown in the drawings.

In the following description, if it is necessary to distinguish a plurality of components from each other, prefixes, such as, “first”, “second”, or the like are attached to names of such components. However, if these components can be distinguished from each other by reference signs attached to those components, such prefixes, such as, “first”, “second”, or the like, may be omitted in consideration of readability of texts.

Note that, in the following description, if it is necessary to distinguish a plurality of components from each other, suffixes, such as, “−1”, “−2”, or the like are attached to reference signs of such components. if there is no need to distinguish such components from each other, such suffixes, such as, “−1”, “−2”, or the like, may be omitted in consideration of readability of texts.

### 1.1 Configurations

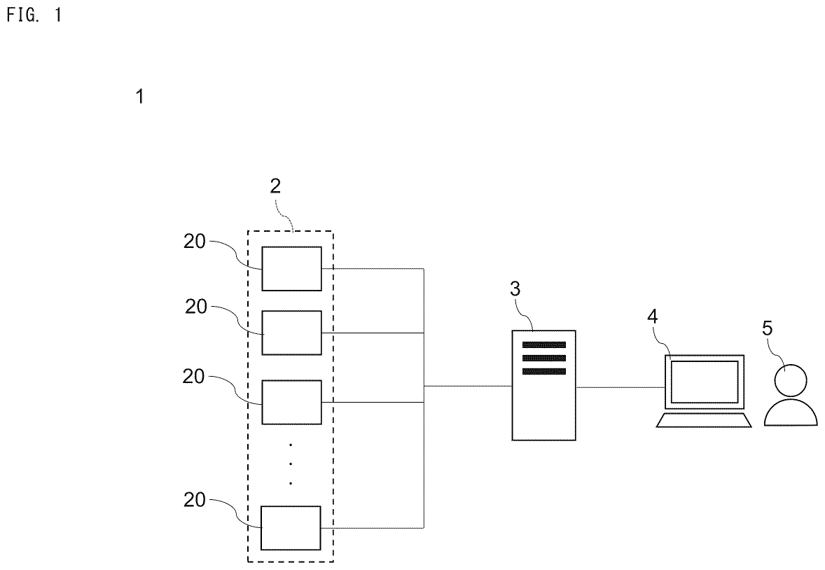

FIG. 1 is a schematic diagram of a manufacturing system 1 according to the present embodiment. The manufacturing system 1 is used for manufacturing a product in a planned manner. The product is manufactured from raw materials through a plurality of processes. The product is not particularly limited, and may include various articles such as food products, pharmaceutical products, electric products, jewelry, furniture, and vehicles. The product is not limited to a finished product, and may be components. Examples of the finished product include an automobile, and examples of the components include a core component of an automobile (such as a piston).

The manufacturing system 1 includes a manufacturing facility 2, a manufacturing plan formulation system 3, and an information terminal 4. The manufacturing plan formulation system 3 and the information terminal 4 constitute an information processing device.

The manufacturing facility 2 is a facility (for example, a factory) where the product is actually manufactured. The manufacturing facility 2 includes a manufacturing line 20 for manufacturing the product by a line production method. The manufacturing line 20 may include one or more manufacturing equipment items that enable manufacturing based on various manufacturing technologies. Examples of the manufacturing technologies include: an additive manufacturing technology (material extrusion, vat photopolymerization, material jetting, binder jetting, powder bed fusion, sheet lamination, directed energy deposition, and the like); a subtractive manufacturing technology (cutting, grinding, electric discharge machining, casting, die casting, pressing, forging, and sheet metal working, and the like); a formative (forming) manufacturing technology (injection molding, extrusion molding, and the like); a surface treatment technology (coating, painting, plating, polishing, and the like); a heat treatment technology (sintering, cooling, and the like); a joining technology (ultrasonic joining, thermal welding, mechanical joining, adhesion, and the like); and an assembly technology (assembly of components, fine pattern transfer (imprinting), impregnation, and the like). The manufacturing line 20 may include not only manufacturing equipment but also measuring equipment, inspection equipment, and conveyance equipment. Examples of the manufacturing facility 2 include, in addition to factories, stores and buildings (the entire building or a floor thereof).

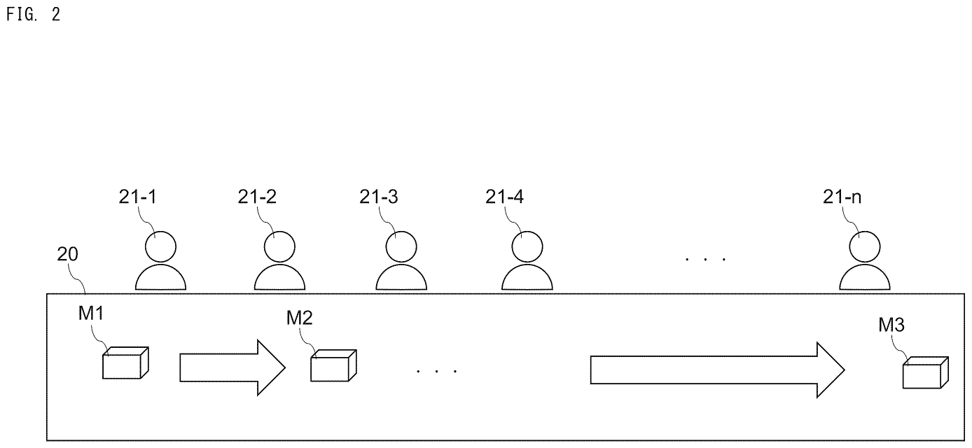

FIG. 2 is a schematic diagram of the manufacturing line 20. The manufacturing line 20 implements a manufacturing process in which a plurality of actors 21-1 to 21-N (N being any integer) perform tasks sequentially. By the plurality of actors 21-1 to 21-N performing tasks sequentially, a finished product M3 is obtained from raw materials M1 through one or more work-in-progress products M2. Each actor 21 is, for example, a worker (human). However, the actor 21 is not limited to a human, as long as the concept of proficiency is applicable. That is, if the speed of completing a task improves through repetition of the same task, the actor 21 may be an apparatus using machine learning instead of a human. The apparatus using machine learning may be, for example, a work machine such as a robot. Accordingly, the manufacturing line 20 may be an automated manufacturing line operated by robots or the like.

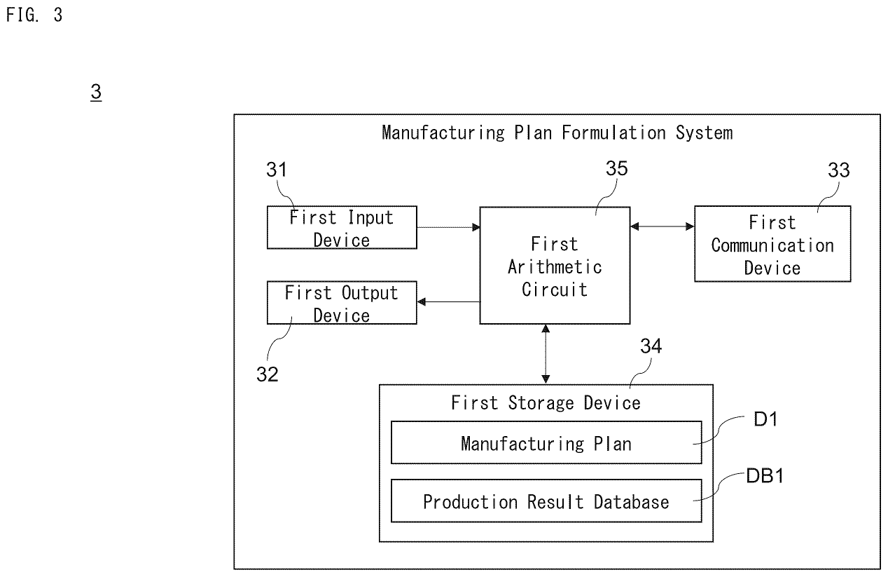

The manufacturing plan formulation system 3 is used to formulate a manufacturing plan for the product manufactured by a manufacturing process in which the plurality of actors 21 perform tasks sequentially. FIG. 3 is a block diagram of the manufacturing plan formulation system 3. The manufacturing plan formulation system 3 includes a first input device 31, a first output device 32, a first communication device 33, a first storage device 34, and a first arithmetic circuit 35. The manufacturing plan formulation system 3 may be implemented by, for example, one or more servers or the like.

The first input device 31 includes one or more human-machine interfaces for inputting information. Examples of human-machine interfaces include input interfaces such as a keyboard, pointing devices (e.g., mouse, trackball), touchpad, or positional input devices of a touch panel display. One or more human-machine interfaces of the first input device 31 may be built into the manufacturing plan formulation system 3 or may be external. That is, the first input device 31 may include human-machine interfaces of the manufacturing plan formulation system 3 itself and human-machine interfaces connected to the manufacturing plan formulation system 3.

The first output device 32 includes one or more human-machine interfaces for outputting information. Examples of human-machine interfaces include output interfaces such as a display, speaker, or display devices of a touch panel display. One or more human-machine interfaces of the first output device 32 may be built into the manufacturing plan formulation system 3 or may be external. That is, the first output device 32 may include human-machine interfaces of the manufacturing plan formulation system 3 itself and human-machine interfaces connected to the manufacturing plan formulation system 3.

The first communication device 33 is used for communication via a communication network. The first communication device 33 includes one or more communication interfaces. The first communication device 33 can be connected to a communication network and has a function to communicate via the communication network. The first communication device 33 conforms to a predetermined communication protocol. The predetermined communication protocol may be selected from various known wired and wireless communication standards.

The first storage device 34 includes one or more storages (non-transitory storage media). The storage may be, for example, any of a hard disk drive, an optical drive, and a solid-state drive (SSD). The storage may be any of a built-in type, an external type, and a network-attached storage (NAS) type.

Information stored in the first storage device 34 include a production result database DB1 and a manufacturing plan D1. The production result database DB1 and the manufacturing plan D1 are not necessarily required to be constantly stored in the first storage device 34. It is sufficient that the production result database DB1 and the manufacturing plan D1 are stored in the first storage device 34 when required by the first arithmetic circuit 35.

The manufacturing plan D1 is a manufacturing plan for the product manufactured by a manufacturing process in which the plurality of actors 21 perform tasks sequentially. In the present embodiment, the manufacturing plan D1 is a plan for manufacturing a target quantity of the product to be manufactured during a first period. Details of the manufacturing plan D1 will be described later.

The production result database DB1 is used for formulating the manufacturing plan D1. The production result database DB1 includes various types of information related to production of the product at the manufacturing facility 2. The production result database DB1 includes a plurality of pieces of production result data. For example, the production result database DB1 includes, for each manufacturing line 20 of the manufacturing facility 2, a plurality of pieces of production result data for different second periods. Each piece of production result data is configured to include, for a corresponding second period, time-series data of an actual production quantity of the product, time-series data of a target production quantity, time-series data of an actual working period, time-series data of a target working period, required-time data indicating a change in required time, and a second indicator value. The second period starts from replacement of the plurality of actors 21. Accordingly, the required-time data indicates a change in required time for the manufacturing process from the replacement of the plurality of actors 21. The required time is time required to complete the manufacturing process, that is, time from the start to the end of the manufacturing process. The required time may also be referred to as cycle time, pitch time, or tact time. In the present embodiment, the change in required time represents a change in required time with respect to elapsed time. It is assumed that there is no replacement of the plurality of actors 21 during the second period. The second period may be, for example, one month, from the first day to the last day of a target month. The second indicator value corresponds to attribute data of a group including a plurality of actors (workers). The attribute data includes a degree of replacement of the plurality of actors (workers). Accordingly, the second indicator value indicates the degree of replacement of the plurality of actors 21 during the second period. The degree of replacement of the plurality of actors 21 may be the number of replacements of the plurality of actors 21 or a replacement ratio of the plurality of actors 21. For example, when six of ten actors 21 are replaced, the number of replacements of the plurality of actors 21 is six, and the replacement ratio of the plurality of actors 21 is 60%.

The first arithmetic circuit 35 is connected to the first input device 31, the first output device 32, and the first communication device 33, and is accessible to the first storage device 34. The first arithmetic circuit 35 may be implemented by, for example, a computer system. The computer system includes one or more processors (microprocessors) and one or more memories. By executing a program (stored in one or more memories or in the first storage device 34), the one or more processors realize various functions of the manufacturing plan formulation system 3. The program may be pre-recorded in the first storage device 34, or may be provided through an electric communication line such as the Internet, or by being recorded on a non-transitory recording medium such as a memory card.

The first arithmetic circuit 35 acquires information on production of the product in each manufacturing line 20 of the manufacturing facility 2 through communication via the first communication device 33, and updates the production result database DB1. As one example, the first arithmetic circuit 35 may communicate with each manufacturing line 20 of the manufacturing facility 2 via the first communication device 33 and acquire, as needed, history data indicating production histories (past logs).

The first arithmetic circuit 35 generates and outputs the manufacturing plan D1 by performing a manufacturing plan formulation method described later.

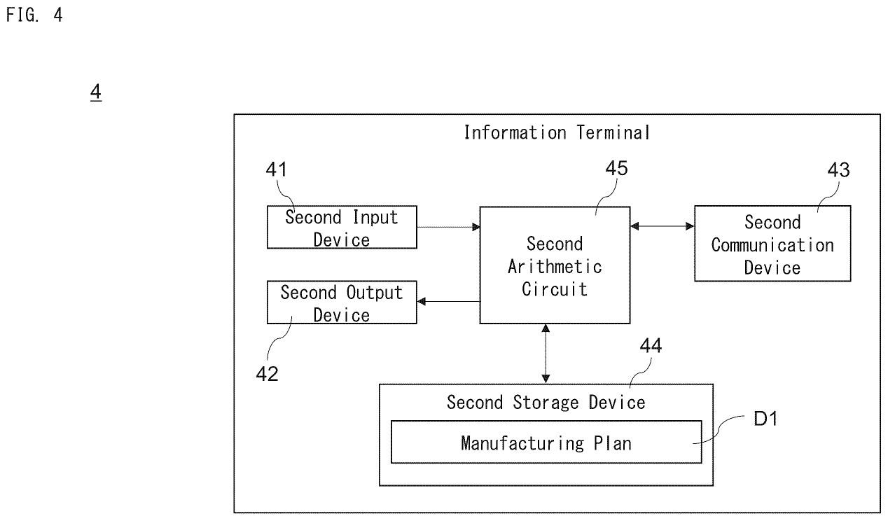

The information terminal 4 is used for input of information by a user 5 and presentation of information to the user 5. FIG. 4 is a block diagram of the information terminal 4. The information terminal 4 includes a second input device 41, a second output device 42, a second communication device 43, a second storage device 44, and a second arithmetic circuit 45. The information terminal 4 may be implemented by, for example, a personal computer (such as a desktop computer or a laptop computer) or a mobile terminal (such as a smartphone or a tablet terminal). Configurations of the second input device 41, the second output device 42, the second communication device 43, the second storage device 44, and the second arithmetic circuit 45 are similar to those of the first input device 31, the first output device 32, the first communication device 33, the first storage device 34, and the first arithmetic circuit 35.

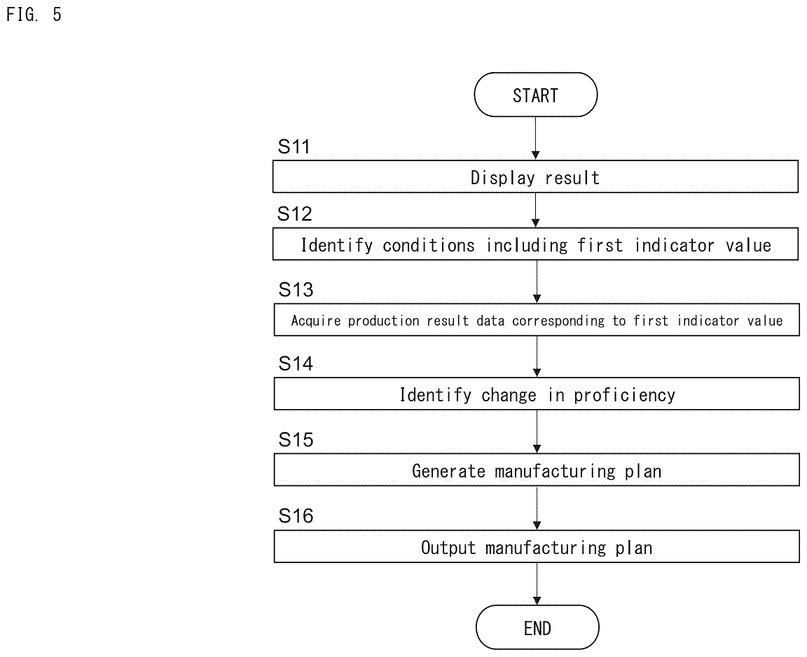

Next, a manufacturing plan formulation method executed by the first arithmetic circuit 35 will be described. FIG. 5 is a flowchart of the manufacturing plan formulation method.

The first arithmetic circuit 35, in formulating the manufacturing plan D1, performs display of a result of the manufacturing line 20 to which the manufacturing plan D1 is to be applied, so that the user 5 can grasp the current situation (S11). More specifically, the first arithmetic circuit 35 transmits information on the result of the manufacturing line 20 to the information terminal 4 through the first communication device 33. The information terminal 4 displays the result of the manufacturing line 20 to the user 5 by means of the second output device 42. The information on the result of the manufacturing line 20 is extracted from the production result database DB1. The information on the result of the manufacturing line 20 may include, for example, time-series data of the actual production quantity of the product, time-series data of the target production quantity, time-series data of the actual working period, time-series data of the target working period, and the required-time data. Thus, the user 5 can easily grasp the difference between the actual production quantity and the target production quantity and the difference between the actual working period and the target working period.

The first arithmetic circuit 35 identifies conditions for formulating the manufacturing plan D1 (S12). The conditions for formulating the manufacturing plan D1 include a first period, a first indicator value, reference time, and a working period.

The first period is a period of time for manufacturing the product according to the manufacturing plan D1. The first period starts from replacement of the plurality of actors 21. It is assumed that there is no replacement of the plurality of actors 21 during the first period. The first period may be, for example, one month, from the first day to the last day of a target month. However, the first period is not limited to one month and may be any arbitrary period such as one week, three months, or one year. The first period includes a plurality of unit periods arranged in chronological order. When the first period is one month, each unit period corresponds to each working day in the month. For example, when the first period is from November 1 to November 30, and November 3 and 23 are holidays, and November 1 is a Wednesday, the working days are November 1, 2, 6-10, 13-17, 20-22, 24, and 27-30, totaling 19 days.

The first indicator value indicates a degree of replacement of the plurality of actors 21 during the first period. In other words, the first indicator value is information on a degree of replacement of a plurality of workers. The degree of replacement of the plurality of actors 21 may be the number of replacements of the plurality of actors 21 or a replacement ratio of the plurality of actors 21. The user 5 can determine the first indicator value based on a planned allocation of the actors 21 of the manufacturing line 20 of the manufacturing facility 2 during the first period.

The reference time is target time for the required time of the manufacturing line 20. The reference time may correspond to required time of the manufacturing line 20 when it is assumed that all of the plurality of actors 21 are sufficiently proficient in performing tasks on the manufacturing line 20. The user 5 can determine the reference time, for example, based on the display of the performance of the manufacturing line 20.

The working period is a period of time used for manufacturing the product during the first period. The first period includes a plurality of unit periods, and the working period is allocated to the plurality of unit periods as a plurality of sub working periods. That is, the working period is a total of the sub working periods. The working period is given as a sum of a first working period that is a fixed value, and a second working period that is a variable value. The first working period is a value determined according to a length of the first period, and the second working period is a value that can be changed. Similarly, each sub working period is given as a sum of a first sub working period that is a fixed value, and a second sub working period that is a variable value. The first sub working period is the same among the plurality of unit periods, while the second sub working period may vary among the unit periods. The first working period is a total of the first sub working periods, and the second working period is a total of the second sub working periods. Note that the second working period may have a value of zero.

For example, when the first period is one month and each unit period is one day, the first sub working period is time required to work in one day, and the second sub working period is additional working period added to the first sub working period per day. As one example, the first working period and the first sub working period correspond to statutory working hours, and the second working period and the second sub working period correspond to overtime working hours.

TABLE 1 below shows one example of settings of the first period and the working period. In TABLE 1, the total of the values in the column of the first sub working period represents the first working period, and the total of the values in the column of the second sub working period represents the second working period. In TABLE 1, the working period is the sum of the first working period and the second working period, which is 9,420 hours.

TABLE 1

| | First Sub Working | Second Sub Working |
|---|---|---|
| Date | Time [min] | Time [min] |
| 11/1 | 435 | 0 |
| 11/2 | 435 | 0 |
| 11/6 | 435 | 120 |
| 11/7 | 435 | 0 |
| 11/8 | 435 | 0 |
| 11/9 | 435 | 0 |
| 11/10 | 435 | 0 |
| 11/13 | 435 | 120 |
| 11/14 | 435 | 0 |
| 11/15 | 435 | 120 |
| 11/16 | 435 | 0 |
| 11/17 | 435 | 0 |
| 11/20 | 435 | 0 |
| 11/21 | 435 | 0 |
| 11/22 | 435 | 120 |
| 11/24 | 435 | 120 |
| 11/27 | 435 | 0 |
| 11/28 | 435 | 0 |
| 11/29 | 435 | 0 |
| 11/30 | 435 | 120 |
| Total | 8700 | 720 |

The first arithmetic circuit 35 communicates, via the first communication device 33, with the second arithmetic circuit 45 of the information terminal 4. The second arithmetic circuit 45 displays, through the second output device 42, an input screen for allowing the user 5 to input conditions for formulating the manufacturing plan D1. While viewing the input screen, the user 5 specifies, via the second input device 41 of the information terminal 4, the manufacturing line 20 that is the subject of the manufacturing plan D1. The manufacturing line 20 may be specified, for example, by information such as the identification number and the model type of the manufacturing line 20. While viewing the input screen, the user 5 can also input, through the second input device 41 of the information terminal 4, the first period, the first indicator value, the reference time, and the working period. The second arithmetic circuit 45 receives the input of the first period, the first indicator value, the reference time, and the working period, and transmits the first period, the first indicator value, the reference time, and the working period to the manufacturing plan formulation system 3 via the second communication device 43. The first arithmetic circuit 35 identifies the first period, the first indicator value, the reference time, and the working period based on the first period, the first indicator value, the reference time, and the working period received from the information terminal 4. Thus, in the manufacturing plan formulation system 3, the second input device 41 and the first communication device 33 are used to obtain the first period, the first indicator value, the reference time, and the working period.

The second arithmetic circuit 45 may further receive input of additional information via the input screen. The additional information may include, for example, a target quantity of the product to be manufactured during the first period, a unit price of the product, and a labor cost required for manufacturing the product. The additional information can be input by the user 5 using the second input device 41. The second arithmetic circuit 45 transmits the additional information to the manufacturing plan formulation system 3 through the second communication device 43.

When the first arithmetic circuit 35 identifies the first indicator value, the first arithmetic circuit 35 acquires production result data corresponding to the first indicator value (S13). More specifically, the first arithmetic circuit 35 retrieves the production result data corresponding to the first indicator value from the production result database DB1. The first arithmetic circuit 35 compares the first indicator value with the second indicator values contained in a plurality of pieces of production result data stored in the production result database DB1. Among the plurality of second indicator values, a second indicator value having the smallest difference from the first indicator value is determined to correspond to the first indicator value. Accordingly, the first arithmetic circuit 35 extracts, as the production result data corresponding to the first indicator value, the production result data having the second indicator value that is closest to the first indicator value. If there exists production result data containing a second indicator value identical to the first indicator value, such production result data is extracted as the production result data corresponding to the first indicator value. If there is no such identical second indicator value, the production result data containing the second indicator value closest to the first indicator value among the plurality of pieces of production result data is extracted as the production result data corresponding to the first indicator value.

The first arithmetic circuit 35 identifies the change in proficiency of the plurality of actors 21 from the start of the first period (S14). The first arithmetic circuit 35 identifies the change in proficiency based on the required-time data included in the production result data corresponding to the first indicator value.

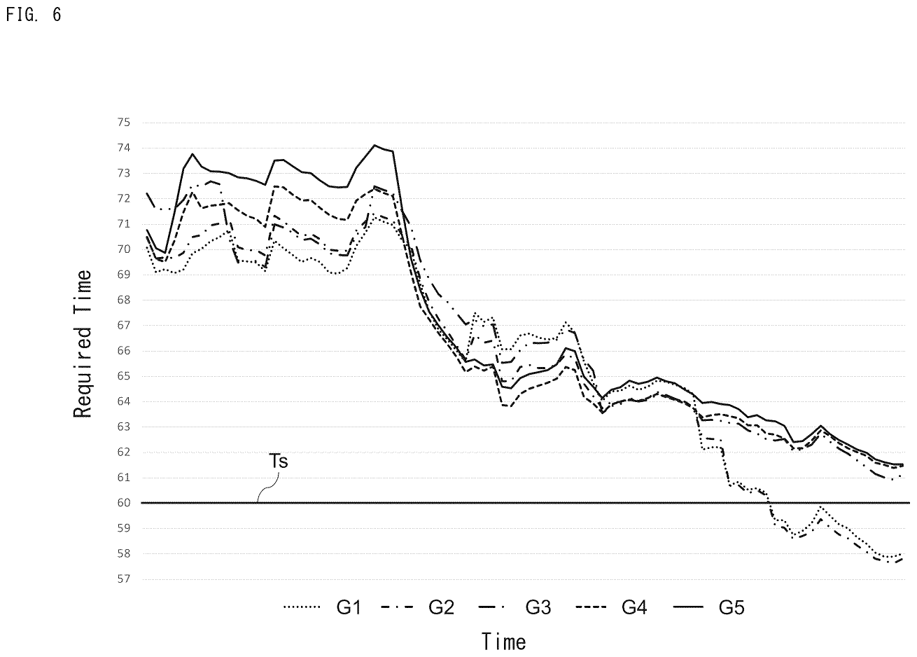

FIG. 6 illustrates examples of required-time data in which the number of replacement among the plurality of actors 21 differs. In FIG. 6, the horizontal axis represents time, and the vertical axis represents the moving average of the median of the required time. The period of the moving average is one day. In FIG. 6, the second indicator values corresponding to G1, G2, G3, G4, and G5 increase in this order; that is, the degree of replacement becomes greater. In FIG. 6, Ts represents the reference time of the required time for the manufacturing line 20. From FIG. 6, it can be understood that the greater the second indicator value, the larger the required time at the beginning of the period, and the longer the time required to reach the reference time Ts.

The change in proficiency is determined based on: a length of a learning interval from the replacement of the plurality of actors 21 until the required time reaches the reference time Ts in the required-time data; and a representative value of the required time within the learning interval. In the present embodiment, the representative value of the required time within the learning interval is the maximum value. Note that other representative values, such as the median or mode, may also be used. In the present embodiment, since the change in required time is a change over time, the unit of the length of the learning interval is time.

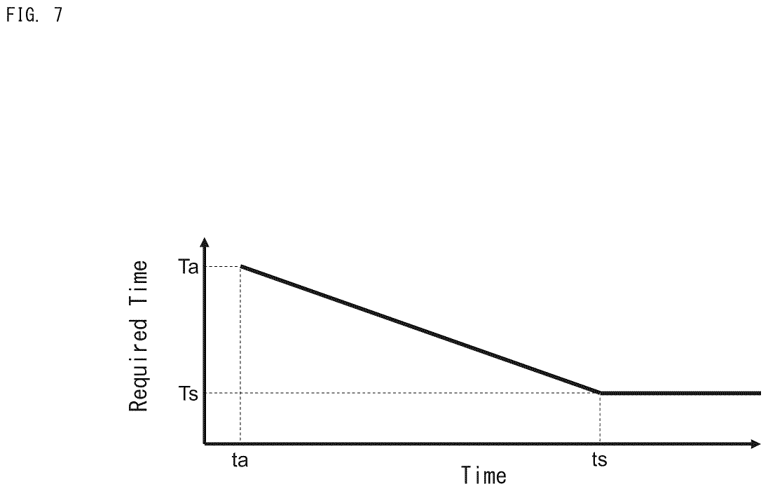

FIG. 7 is a graph showing a first example of the change in proficiency. In the first example, the required time is used as an indicator of proficiency. The shorter the required time, the higher the proficiency. The first example is suitable for cases where proficiency is assumed to change linearly. In FIG. 7, ta represents the time point of the replacement of the plurality of actors 21, and ts represents the time point at which the required time reaches the reference time Ts. The period from time ta to ts is the learning interval. Ta represents the representative value (in the present embodiment, the maximum value) of the required time within the learning interval. Letting time be denoted by t and the required time by T, the graph in FIG. 7 can be expressed by the following equations (1) and (2).

$$[ MATHEMATICAL FORMULA 1 ]$$

$$T = \frac{Ts - Ta}{ts - ta} ( t - ts ) + Ts ( t < ts ) \qquad ( 1 )$$

$$T = Ts ( t \geq ts ) \qquad ( 2 )$$

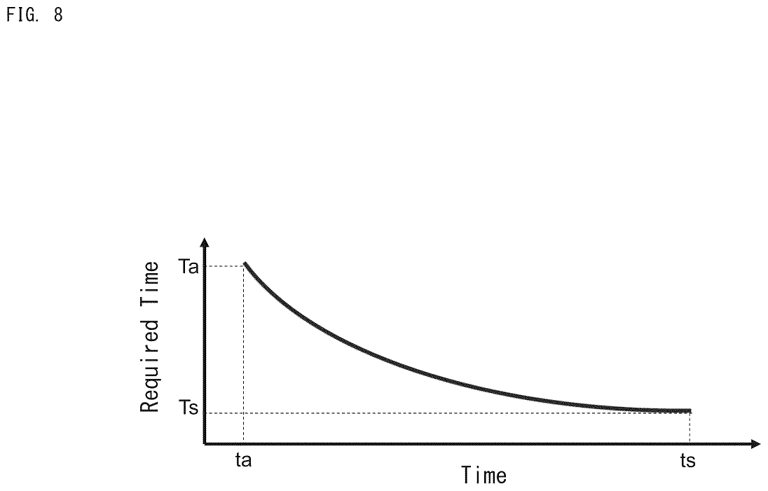

FIG. 8 is a graph showing a second example of the change in proficiency. As in the first example, the second example uses the required time as an indicator of proficiency. The second example is suitable for cases where proficiency is assumed to change curvilinearly. The graph in FIG. 8 is expressed by the following equation (3). In the equation (3), C1 and C2 are proficiency parameters that can be determined by fitting to the required-time data.

$$[ MATHEMATICAL FORMULA 2 ]$$

$$T = Ts + {c}_{1} \frac{1}{t} + {c}_{2} \qquad ( 3 )$$

The above equations (1) and (2), or the above equation (3) can be regarded as models that model the change in proficiency over time for a group consisting of a plurality of workers. The first arithmetic circuit 35 can perform a proficiency simulation by matching the model based on the obtained degree of replacement of the plurality of workers. Through this proficiency simulation, the change in proficiency can be obtained.

Referring again to FIG. 5, the first arithmetic circuit 35 generates the manufacturing plan D1 (S15). In generating the manufacturing plan D1, the scheduled quantity of the product to be manufactured during the first period is calculated. The scheduled quantity is determined based on the working period used for manufacturing the product in the first period and the change in proficiency. In order to reflect the change in proficiency in the scheduled quantity, the scheduled quantity is given as the sum of production quantities of the product in a plurality of unit periods. In each of the plurality of unit periods, the production quantity of the product is determined based on the sub working period at the unit period in the working period and the proficiency at the unit period calculated from the change in proficiency.

For example, the first example shown in FIG. 7 is applied to a change in proficiency. When the reference time Ts is 60 seconds, the representative value Ta is 100 seconds, and a learning interval (a number of days between ts and ta) is 10 days, a change in required time T indicating the change in proficiency is as shown in TABLE 2 below. In Table 2, a proficiency ratio is given by T/Ts, and a proficiency loss ratio is given by Ts/T. The proficiency ratio and the proficiency loss ratio can be used as indicators of proficiency instead of the required time T.

TABLE 2

| | Required | Proficiency Ratio | Proficiency Loss |
|---|---|---|---|
| Date | Time T | (T/Ts) | Ratio (Ts/T) |
| 11/1 | 100 | 1.67 | 0.60 |
| 11/2 | 96 | 1.60 | 0.63 |
| 11/6 | 92 | 1.53 | 0.65 |
| 11/7 | 88 | 1.47 | 0.68 |
| 11/8 | 84 | 1.40 | 0.71 |
| 11/9 | 80 | 1.33 | 0.75 |
| 11/10 | 76 | 1.27 | 0.79 |
| 11/13 | 72 | 1.20 | 0.83 |
| 11/14 | 68 | 1.13 | 0.88 |
| 11/15 | 64 | 1.07 | 0.94 |
| 11/16 | 60 | 1.00 | 1.00 |
| 11/17 | 60 | 1.00 | 1.00 |
| 11/20 | 60 | 1.00 | 1.00 |
| 11/21 | 60 | 1.00 | 1.00 |
| 11/22 | 60 | 1.00 | 1.00 |
| 11/24 | 60 | 1.00 | 1.00 |
| 11/27 | 60 | 1.00 | 1.00 |
| 11/28 | 60 | 1.00 | 1.00 |
| 11/29 | 60 | 1.00 | 1.00 |
| 11/30 | 60 | 1.00 | 1.00 |

In the present embodiment, when the required time T is used as the proficiency, the production quantity of the product is obtained by dividing the sub working period by the required time T. When the proficiency loss ratio is adopted as the proficiency, the production quantity of the product is obtained by multiplying the value obtained by dividing the sub working period by the reference time Ts by the proficiency loss ratio.

TABLE 3 below shows the production quantity of the product for each unit period, as determined from TABLE 1 and TABLE 2. Furthermore, TABLE 3 shows the production quantity of the product during the first sub working period and the production quantity of the product during the second sub working period for each unit period. The production quantity of the product for each unit period is the total of the production quantity during the first sub working period and the production quantity of the product during the second sub working period of that unit period.

TABLE 3

| | Production Quantity | Production Quantity | |
|---|---|---|---|
| | during First Sub | during Second Sub | Production |
| Date | Working Period | Working Period | Quantity |
| 11/1 | 261 | 0 | 261 |
| 11/2 | 272 | 0 | 272 |
| 11/6 | 284 | 78 | 362 |
| 11/7 | 297 | 0 | 297 |
| 11/8 | 311 | 0 | 311 |
| 11/9 | 326 | 0 | 326 |
| 11/10 | 343 | 0 | 343 |
| 11/13 | 363 | 100 | 463 |
| 11/14 | 384 | 0 | 384 |
| 11/15 | 408 | 112 | 520 |
| 11/16 | 435 | 0 | 435 |
| 11/17 | 435 | 0 | 435 |
| 11/20 | 435 | 0 | 435 |
| 11/21 | 435 | 0 | 435 |
| 11/22 | 435 | 120 | 555 |
| 11/24 | 435 | 120 | 555 |
| 11/27 | 435 | 0 | 435 |
| 11/28 | 435 | 0 | 435 |
| 11/29 | 435 | 0 | 435 |
| 11/30 | 435 | 120 | 555 |
| Total | 7599 | 650 | 8249 |

The scheduled quantity is the total production quantity of the product over a plurality of unit periods, and in the case of TABLE 3, it is 8,249. The scheduled quantity includes a first scheduled quantity corresponding to the first working period and a second scheduled quantity corresponding to the second working period. The first scheduled quantity is 7,599, and the second scheduled quantity is 650. In this manner, the scheduled quantity of the product to be manufactured during the first period is determined. Since the scheduled quantity is calculated using the change in proficiency during the first period, when the product is actually manufactured according to the manufacturing plan D1, it is highly likely that the quantity of the product obtained will match or approximate the scheduled quantity specified in the manufacturing plan D1. Accordingly, the feasibility of the manufacturing plan D1 can be improved.

The manufacturing plan D1 includes, in addition to the scheduled quantity of products to be manufactured during the first period, a production quantity of the product for each of the plurality of unit periods arranged in chronological order within the first period. The production quantity of the product for each of the plurality of unit periods is obtained during the process of calculating the scheduled quantity. The production quantity for each unit period is calculated using the change in proficiency during the first period. Therefore, when the product is actually manufactured according to the manufacturing plan D1, it becomes highly probable that the quantity of the product obtained will match or approximate the production quantity for each unit period specified in the manufacturing plan D1. Accordingly, the feasibility of the manufacturing plan D1 is further improved.

The manufacturing plan D1 also includes a sales amount of the product based on the scheduled quantity. The sales amount based on the scheduled quantity is calculated from the scheduled quantity and the unit price of the product. As one example, the sales amount based on the scheduled quantity is obtained by multiplying the scheduled quantity by the unit price of the product.

The manufacturing plan D1 includes a manufacturing cost of the product based on the second working period, and a sales amount of products based on the second scheduled quantity. The manufacturing cost of the product based on the second working period is calculated from the second working period and a labor cost. As one example, the manufacturing cost of the product based on the second working period is obtained by multiplying the second working period by the labor cost. The sales amount of the product based on the second scheduled quantity is calculated from the second scheduled quantity and the unit price of the product. As one example, the sales amount of the product based on the second scheduled quantity is obtained by multiplying the second scheduled quantity by the unit price of the product.

The manufacturing plan D1 further includes a target quantity of the product to be manufactured during the first period, and a target value of the working period in the first period. The target quantity of the product to be manufactured during the first period and the target value of the working period in the first period are extracted from the additional information.

The manufacturing plan D1 may include the conditions for formulating the manufacturing plan D1, the first period, the first indicator value, the reference time, and the working period.

The first arithmetic circuit 35 outputs the manufacturing plan D1 thus obtained (S16). The first arithmetic circuit 35 transmits the information of the manufacturing plan D1 to the information terminal 4 via the first communication device 33.

The information terminal 4 presents the manufacturing plan D1 received from the manufacturing plan formulation system 3 to the user 5 via the second output device 42. In the information terminal 4, the second arithmetic circuit 45 can generate graphical information or a GUI (Graphical User Interface) representing the manufacturing plan D1 based on the proficiency simulation.

The second arithmetic circuit 45 can present the scheduled quantity of the product to be manufactured during the first period, based on the manufacturing plan D1. The scheduled quantity may be displayed in association with the production quantity of the second sub working period. As one example, the scheduled quantity may be displayed together with the total of the second sub working period and the production quantity of the second sub working period. In the case of TABLE 1, the total working period is 9,420 minutes, and the total second sub working period is 720 minutes. In this case, from TABLE 3, the scheduled quantity is 8,249, of which 650 correspond to the production quantity of the second sub working period. The second arithmetic circuit 45 may display, in a tabular format as shown in TABLE 4, both the results indicating the production quantity and the working period of the first period, and the increment showing the production quantity and total of the second sub working period. This allows the user 5 to easily grasp the extent to which the second sub working period should be adjusted in order to modify the scheduled quantity of the product, thereby facilitating consideration of revisions to the manufacturing plan D1.

TABLE 4

| | Result | Increment |
|---|---|---|
| Production Quantity during First Period | 8249 | +650 |
| Working Period within First Period | 9420 min | +720 min |

The scheduled quantity may be displayed in association with the target quantity of the product to be manufactured during the first period. As one example, the scheduled quantity may be displayed together with the difference between the scheduled quantity and the target quantity, as well as the working period corresponding to the difference between the target quantity and the scheduled quantity. The working period corresponding to the difference between the target quantity and the scheduled quantity is determined from the difference between the target quantity and the scheduled quantity, and the reference time. As one example, when the target quantity is 8,000, the difference between the target quantity and the scheduled quantity is +249, and the working period corresponding to this difference is +249 minutes. The second arithmetic circuit 45 may display, in a tabular format as shown in TABLE 5, the scheduled quantity, the difference between the scheduled quantity and the target quantity, the working period, and the working period corresponding to the difference between the target quantity and the scheduled quantity. This allows the user 5 to easily grasp the extent to which the working period should be adjusted in order to make the scheduled quantity of the product match the target quantity, thereby facilitating consideration of revisions to the manufacturing plan D1.

TABLE 5

| | Result | Difference |
|---|---|---|
| Production Quantity during First Period | 8249 | +249 |
| Working Period within First Period | 9240 min | +249 min |

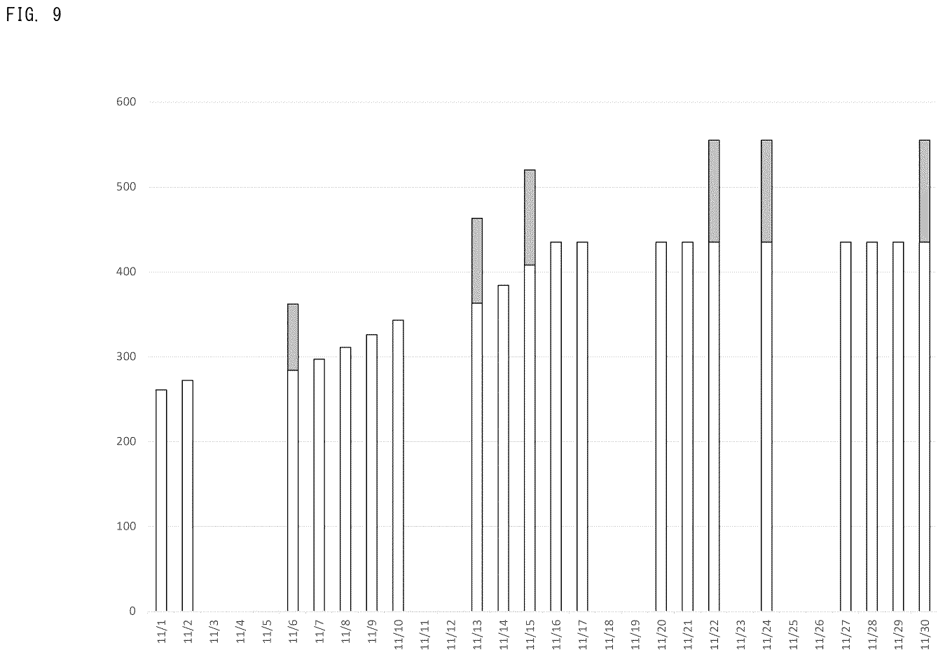

The second arithmetic circuit 45 presents, based on the manufacturing plan D1, the production quantity of the product for each of a plurality of unit periods arranged in chronological order within the first period. The production quantity of the product in each unit period may be divided into the production quantity during the first sub working period and the production quantity during the second sub working period. This allows the user 5 to easily understand the working period and to readily consider revisions to the manufacturing plan D1. The second arithmetic circuit 45 may display the production quantity of each unit period in a graphical format. FIG. 9 is a bar graph showing the production quantity for each unit period according to the manufacturing plan. In FIG. 9, the white bars represent the production quantity during the first sub working period, and the gray bars represent the production quantity during the second sub working period.

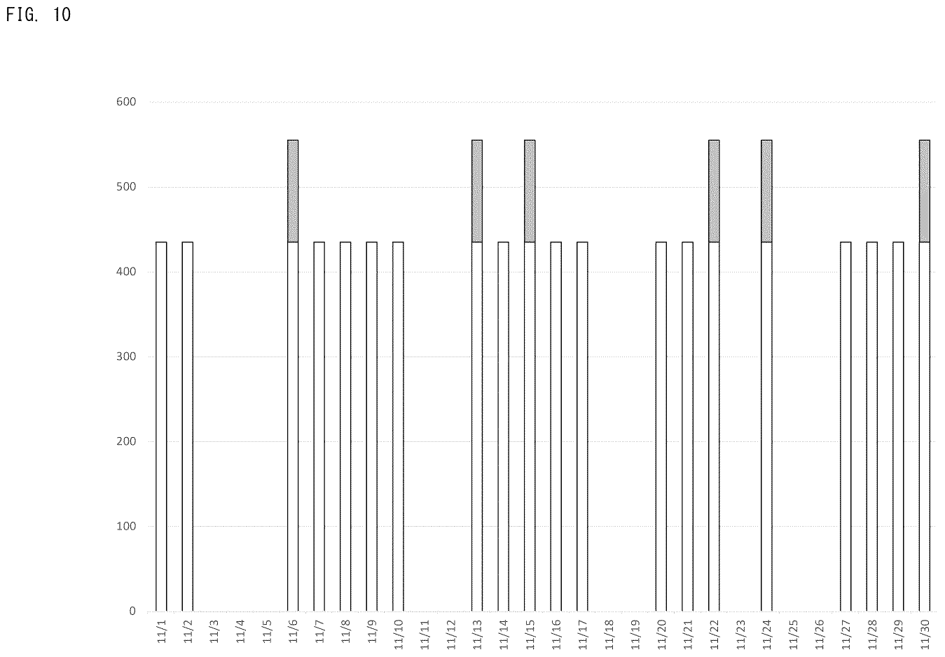

The second arithmetic circuit 45 presents, based on the manufacturing plan D1, the sub working period for each of a plurality of unit periods arranged in chronological order within the first period. In particular, the sub working period may be divided into the first sub working period and the second sub working period. This enables the user 5 to easily grasp the working period and to readily consider revisions to the manufacturing plan D1. The second arithmetic circuit 45 may display the sub working period of each unit period in a graphical format. FIG. 10 is a bar graph showing the sub working period for each unit period according to the manufacturing plan. In FIG. 10, the white bars represent the first sub working period, and the gray bars represent the second sub working period.

The second arithmetic circuit 45 presents, based on the manufacturing plan D1, the sales amount of the product based on the scheduled quantity. This allows the user 5 to easily understand the sales amount of the product.

The second arithmetic circuit 45, based on the manufacturing plan D1, presents the manufacturing cost of the product based on the second working period, and the sales amount of the product based on the second scheduled quantity. This allows the user 5 to consider revisions to the manufacturing plan D1 based on a comparison between the manufacturing cost of the product determined from the second working period and the sales amount determined from the second scheduled quantity.

As described above, the user 5 can refer to the manufacturing plan D1 presented on the second output device 42 of the information terminal 4, and modify, as necessary, the conditions for formulating the manufacturing plan D1, the first period, the first indicator value, the reference time, and the working period, thereby revising the manufacturing plan D1. In the present embodiment, the working period is divided into the first working period that is a fixed value, and the second working period that is a variable value, and the first working period and the second working period can be identified separately. Therefore, the user 5 can adjust the second working period such that the working period corresponding to the difference between the target quantity and the scheduled quantity approaches zero, thereby bringing the scheduled quantity closer to the target quantity. When the user 5 decides to adopt the manufacturing plan D1, the manufacturing plan D1 may be output from the information terminal 4 and applied to the actual production plan.

In the manufacturing plan formulation method described above, it is possible to identify the change in proficiency of the manufacturing line 20 according to the degree of replacement of the plurality of actors 21 of the manufacturing line 20. Therefore, the manufacturing plan D1 that can actually be executed on the manufacturing line 20 can be formulated. Accordingly, it becomes possible to accurately understand the overall outlook of plans for the factory or the entire supply chain.

### 1.2 Advantageous Effects

The aforementioned manufacturing plan formulation method is a manufacturing plan formulation method performed by an arithmetic circuit (the first arithmetic circuit 35) for formulating a manufacturing plan D1 for a product to be manufactured by a manufacturing process in which a plurality of actors 21 perform tasks sequentially, and includes: identifying a first indicator value indicating a degree of replacement of the plurality of actors 21 during a first period; identifying, based on the first indicator value, a change in proficiency of the plurality of actors 21 from a start of the first period; and outputting a manufacturing plan D1 of the product for the first period based on the change in proficiency. This configuration enables improvement in feasibility of the manufacturing plan D1.

In the manufacturing plan formulation method, the arithmetic circuit (the first arithmetic circuit 35) is accessible to a manufacturing result database DB1 including a plurality of pieces of manufacturing result data. Each of the plurality of pieces of manufacturing result data includes required-time data indicating a change in required time of the manufacturing process due to replacement of the plurality of actors 21, and a second indicator value indicating a degree of the replacement of the plurality of actors 21. The change in proficiency is identified based on required-time data included in manufacturing result data that is one of the plurality of pieces of manufacturing result data and includes a second indicator value corresponding to the first indicator value. This configuration enables a further improvement in the feasibility of the manufacturing plan D1, since the change in proficiency is identified based on the actual result.

In the manufacturing plan formulation method, wherein the change in proficiency is determined based on: a length of a learning interval from replacement of the plurality of actors 21 until required time reaches reference time in the required-time data; and a representative value of required time within the learning interval in the required-time data. This configuration enables further improvement in feasibility of the manufacturing plan D1.

In the manufacturing plan formulation method, the representative value is a maximum value. This configuration enables further improvement in feasibility of the manufacturing plan D1.

In the manufacturing plan formulation method, among second indicator values of the plurality of pieces of manufacturing result data, a second indicator value having a smallest difference from the first indicator value is determined to correspond to the first indicator value. This configuration enables further improvement in feasibility of the manufacturing plan D1.

In the manufacturing plan formulation method, the manufacturing plan D1 includes a scheduled quantity of the product to be manufactured during the first period. This configuration can facilitate consideration of revisions to the manufacturing plan D1.

In the manufacturing plan formulation method, the manufacturing plan D1 includes a target quantity of the product to be manufactured during the first period. This configuration can facilitate consideration of revisions to the manufacturing plan D1.

In the manufacturing plan formulation method, the scheduled quantity is determined based on a working period used for manufacturing the product during the first period and the change in proficiency. This configuration enables further improvement in feasibility of the manufacturing plan D1.

In the manufacturing plan formulation method, the manufacturing plan includes a production quantity of the products for each of a plurality of unit periods arranged in chronological order in the first period. in each of the plurality of unit periods, the production quantity is given by a sub working period at the unit period in the working period and proficiency at the unit period obtained from the change in proficiency. This configuration can facilitate consideration of revisions to the manufacturing plan D1.

In the manufacturing plan formulation method, the manufacturing plan includes a sales amount of the product based on the scheduled quantity. This configuration can facilitate consideration of revisions to the manufacturing plan D1.

In the manufacturing plan formulation method, the working period is a sum of a first working period that is a fixed value, and a second working period that is a variable value. The first working period and the second working period are identified separately. This configuration can facilitate consideration of revisions to the manufacturing plan D1.

In the manufacturing plan formulation method, the scheduled quantity includes a first scheduled quantity corresponding to the first working period and a second scheduled quantity corresponding to the second working period. The manufacturing plan includes a manufacturing cost of the products based on the second working period and a sales amount of the products based on the second scheduled quantity. This configuration can facilitate consideration of revisions to the manufacturing plan D1.

The aforementioned manufacturing plan formulation system 3 is a manufacturing plan formulation system for formulating a manufacturing plan D1 for a product to be manufactured by a manufacturing process in which a plurality of actors 21 perform tasks sequentially, and includes a first arithmetic circuit 35. The first arithmetic circuit 35 is configured to: identify a first indicator value indicating a degree of replacement of the plurality of actors 21 during a first period; identify, based on the first indicator value, a change in proficiency of the plurality of actors 21 from a start of the first period; and output a manufacturing plan D1 of the product for the first period based on the change in proficiency. This configuration enables improvement in feasibility of the manufacturing plan D1.

The aforementioned program is a program for enabling the above manufacturing plan formulation method to be performed by the first arithmetic circuit 35. This configuration enables improvement in feasibility of the manufacturing plan D1.

The aforementioned information terminal 4 is communicably connected to the manufacturing plan formulation system 3, and includes the second input device 41, the second output device 42, the second communication device 43, and the second arithmetic circuit 45 configured to control the second input device 41, the second output device 42, and the second communication device 43. The second arithmetic circuit 45 is configured to receive, by the second input device 41, input of the first indicator value; send, by the second communication device 43, the first indicator value to the manufacturing plan formulation system 3 to receive the manufacturing plan D1 from the manufacturing plan formulation system 3; and present, by the second output device 42, the manufacturing plan D1. This configuration enables improvement in feasibility of the manufacturing plan D1.

### 2. Variations

Embodiments of the present disclosure are not limited to the embodiment described above. The above embodiment may be variously modified in accordance with design and other factors, provided that the objects of the present disclosure can be achieved. Hereinafter, variations of the above embodiment will be enumerated. The variations described below may be applied in appropriate combinations.

In one variation, the first arithmetic circuit 35 may identify the change in proficiency by using a trained model. The trained model may be stored, for example, in the first storage device 34, but is not limited thereto. That is, as long as the first arithmetic circuit 35 can access the trained model, it may be stored in an external storage such as a server. As shown in FIG. 6, it is understood that the larger the second indicator value (i.e., the higher the degree of replacement), the greater the required time at the beginning of the cycle and the longer the time required to reach the reference time Ts. Thus, it can be considered that there is a correlation among the degree of replacement, the elapsed time since the replacement, and the proficiency. Accordingly, when determining the change in proficiency, it is conceivable to use a trained model that has learned such correlation. Specifically, the trained model may include one or more trained parameters generated by machine learning (for example, supervised learning) using a training dataset, and an inference program in which the one or more trained parameters are incorporated. The degree of replacement may be represented by the first indicator value. The elapsed time since the replacement may be represented by the elapsed time since the start of the first period. Thus, the training dataset includes, as an input, the first indicator value and the elapsed time from the start of the first period, and as output, an indicator of proficiency. The indicator of proficiency may be selected from proficiency itself, required time, a proficiency ratio, or a proficiency loss ratio. The inference program may be a known type of program, such as a logistic regression model or a neural network model. As described above, the first arithmetic circuit 35 may be accessible to the trained model. The trained model may include one or more trained parameters generated by machine learning using a training dataset, and an inference program in which the one or more trained parameters are incorporated. The training dataset may include, as input, the first indicator value and the elapsed time since the start of the first period, and as output, the indicator of proficiency. The first arithmetic circuit 35 may be configured to identify the change in proficiency by using the trained model. In other words, the first arithmetic circuit 35 may input the first indicator value and the elapsed time since the start of the first period into the trained model to obtain the indicator of proficiency as output from the trained model, and thereby identify the change in proficiency.

In one variation, when acquiring the production result data corresponding to the first indicator value, it is preferable to use the production result data related to the manufacturing line 20 that is the subject of the manufacturing plan D1. However, there may not always be preferable production result data for the target manufacturing line 20 that is the subject of the manufacturing plan D1. For example, if for the manufacturing line 20 that is the subject of the manufacturing plan D1, there is no production result data in which the difference between the first indicator value and the second indicator value is less than or equal to a threshold, it is acceptable to use production result data for another manufacturing line 20 considered to be similar to the manufacturing line 20 that is the subject of the manufacturing plan D1. Such a manufacturing line 20 considered to be similar to the manufacturing line 20 that is the subject of the manufacturing plan D1 may be, for example, a manufacturing line 20 of the same model type as the manufacturing line 20 that is the subject of the manufacturing plan D1, or one that exhibits a similar pattern of change in required time.

In one variation, the reference time need not necessarily be input by the user 5. The reference time may be predetermined for each model type of the manufacturing line 20. In such a case, by identifying the model type of the manufacturing line 20, the reference time can be specified from a table showing the relationship between the model type and the reference time.

In one variation, the first period, the first indicator value, the reference time, and the working period do not have to be input at the same time. Once the first indicator value is input, the change in proficiency can be identified. Therefore, it is possible to accept input of the first period, the reference time, and the working period after presenting a graph of the change in proficiency (see FIGS. 7 and 8).

In one variation, the change in required time may be represented as a change in required time with respect to the number of times the product is manufactured. In this case, since the unit of the learning interval from the replacement of the plurality of actors 21 until the required time reaches the reference time Ts in the required-time data is the number of times, the change in proficiency is also expressed as a change with respect to the number of times the product is manufactured.

In one variation, the manufacturing plan D1 is not necessarily limited to the above-described embodiment, as long as it includes at least the scheduled quantity of the product to be manufactured during the first period. For example, the manufacturing plan D1 need not include the production quantity of the product for each of the plurality of unit periods arranged chronologically in the first period. Furthermore, the manufacturing plan D1 need not include the target quantity of the product to be manufactured during the first period. Additionally, the manufacturing plan D1 need not include the first period, the first indicator value, the reference time, and/or the working period. Moreover, the manufacturing plan D1 need not include the sales amount based on the scheduled quantity, the manufacturing cost based on the second working period, or the sales amount based on the second scheduled quantity. On the other hand, the manufacturing plan D1 may include information on the change in proficiency identified by the first indicator value, and such change in proficiency may be presented to the user 5.

In one variation, the manufacturing plan formulation system 3 may be implemented by a computer system comprising a plurality of servers or similar devices. It is not essential that all functions (components) of the manufacturing plan formulation system 3 be housed within a single housing; rather, its components may be distributed across multiple housings. Furthermore, at least part of the functions of the manufacturing plan formulation system 3, such as a portion of the functions of the first arithmetic circuit 35, may be implemented through cloud computing or similar technology.

In one variation, the manufacturing plan formulation system 3 and the information terminal 4 may be implemented as a single computer system. For example, the multiple functions (components) of the manufacturing plan formulation system 3 and the information terminal 4 may be integrated within a single housing.

### 3. Aspects

As apparent from the above embodiment and variations, the present disclosure includes the following aspects.

### Aspect 1

A manufacturing plan formulation method performed by an arithmetic circuit for formulating a manufacturing plan for a product to be manufactured by a manufacturing process in which a plurality of actors perform tasks sequentially, comprising:
identifying a first indicator value indicating a degree of replacement of the plurality of actors during a first period;
identifying, based on the first indicator value, a change in proficiency of the plurality of actors from a start of the first period; and
outputting a manufacturing plan of the product for the first period based on the change in proficiency.

### Aspect 2

The manufacturing plan formulation method of aspect 1, wherein:
the arithmetic circuit is accessible to a manufacturing result database including a plurality of pieces of manufacturing result data;
each of the plurality of pieces of manufacturing result data includes required-time data indicating a change in required time of the manufacturing process due to replacement of the plurality of actors, and a second indicator value indicating a degree of the replacement of the plurality of actors; and
the change in proficiency is identified based on required-time data included in manufacturing result data that is one of the plurality of pieces of manufacturing result data and includes a second indicator value corresponding to the first indicator value.

### Aspect 3

The manufacturing plan formulation method of aspect 2, wherein the change in proficiency is determined based on: a length of a learning interval from replacement of the plurality of actors until required time reaches reference time in the required-time data; and a representative value of required time within the learning interval in the required-time data.

### Aspect 4

The manufacturing plan formulation method of aspect 3, wherein the representative value is a maximum value.

### Aspect 5

The manufacturing plan formulation method of any one of aspects 2 to 4, wherein among second indicator values of the plurality of pieces of manufacturing result data, a second indicator value having a smallest difference from the first indicator value is determined to correspond to the first indicator value.

### Aspect 6

The manufacturing plan formulation method of aspect 1, wherein:
the arithmetic circuit is accessible to a trained model;
the trained model includes one or more trained parameters generated by machine learning using a training dataset, and an inference program in which the one or more trained parameters are incorporated;
the training dataset includes, as input, the first indicator value and elapsed time since the start of the first period, and includes, output, an indicator of proficiency; and
the arithmetic circuit is configured to identify the change in proficiency by using the trained model.

### Aspect 7

The manufacturing plan formulation method of any one of aspects 1 to 6, wherein the manufacturing plan includes a scheduled quantity of the product to be manufactured during the first period.

### Aspect 8

The manufacturing plan formulation method of aspect 7, wherein the manufacturing plan includes a target quantity of the product to be manufactured during the first period.

### Aspect 9

The manufacturing plan formulation method of aspect 7 or 8, wherein the scheduled quantity is determined based on a working period used for manufacturing the product during the first period and the change in proficiency.

### Aspect 10

The manufacturing plan formulation method of aspect 9, wherein:
the manufacturing plan includes a production quantity of the products for each of a plurality of unit periods arranged in chronological order in the first period; and
in each of the plurality of unit periods, the production quantity is given by a sub working period at the unit period in the working period and proficiency at the unit period obtained from the change in proficiency.

### Aspect 11

The manufacturing plan formulation method of any one of aspects 7 to 10, wherein the manufacturing plan includes a sales amount of the product based on the scheduled quantity.

### Aspect 12

The manufacturing plan formulation method of aspect 9 or 10, wherein:
the working period is a sum of a first working period that is a fixed value, and a second working period that is a variable value; and
the first working period and the second working period are identified separately.

### Aspect 13

The manufacturing plan formulation method of aspect 12, wherein:
the scheduled quantity includes a first scheduled quantity corresponding to the first working period and a second scheduled quantity corresponding to the second working period; and
the manufacturing plan includes a manufacturing cost of the products based on the second working period and a sales amount of the products based on the second scheduled quantity.

### Aspect 14

A manufacturing plan formulation system for formulating a manufacturing plan for a product to be manufactured by a manufacturing process in which a plurality of actors perform tasks sequentially, comprising a first arithmetic circuit,
the first arithmetic circuit being configured to:
   identify a first indicator value indicating a degree of replacement of the plurality of actors during a first period;
   identify, based on the first indicator value, a change in proficiency of the plurality of actors from a start of the first period; and
   output a manufacturing plan of the product for the first period based on the change in proficiency.

### Aspect 15

A program for enabling the manufacturing plan formulation method of any one of aspects 1 to 13 to be performed by the arithmetic circuit.

### Aspect 16

An information terminal to be communicably connected to the manufacturing plan formulation system of aspect 14, comprising:
an input device;
an output device;
a communication device; and
a second arithmetic circuit configured to control the input device, the output device, and the communication device,
the second arithmetic circuit being configured to:
   receive, by the input device, input of the first indicator value;
   send, by the communication device, the first indicator value to the manufacturing plan formulation system to receive the manufacturing plan from the manufacturing plan formulation system; and
   present, by the output device, the manufacturing plan.

### Aspect 17

An information processing device comprising:
a storage device configured to accumulate attribute data of a group including a plurality of workers performing a manufacturing process;
a model that models a change in proficiency with respect to a period for the group including the plurality of workers in the entire manufacturing process;
an input device or a communication device configured to acquire information indicating a degree of replacement of the plurality of workers; and
one or more arithmetic circuits configured to store, in the storage device, the acquired information indicating the degree of replacement of the plurality of workers, to perform a simulation of the proficiency by matching the model based on the acquired degree of replacement of the plurality of workers, and to generate graph information or a GUI indicating a manufacturing plan based on the simulation of the proficiency.

Aspects 2 to 13 are optional and not essential. Aspects 2 to 13 can be combined with any of aspects 14, 16, 17 appropriately.

### INDUSTRIAL APPLICABILITY

The present disclosure is applicable to manufacturing plan formulation methods, manufacturing plan formulation systems, programs, and information terminals. In particular, the present disclosure is applicable to a manufacturing plan formulation method, a manufacturing plan formulation system, a program, and an information terminal, for formulating a manufacturing plan for products to be manufactured by a manufacturing process in which a plurality of actors perform tasks sequentially.

### REFERENCE SIGNS LIST

21 Actor
3 Manufacturing Plan Formulation System
35 First Arithmetic Circuit (Arithmetic Circuit)
4 Information Terminal
41 Second Input Device (Input Device)
42 Second Output Device (Output Device)
43 Second Communication Device (Communication Device)
45 Second Arithmetic Circuit
D1 Manufacturing Plan

1. A manufacturing plan formulation method performed by an arithmetic circuit for formulating a manufacturing plan for a product to be manufactured by a manufacturing process in which a plurality of actors perform tasks sequentially, comprising:
identifying a first indicator value indicating a degree of replacement of the plurality of actors during a first period;
identifying, based on the first indicator value, a change in proficiency of the plurality of actors from a start of the first period; and
outputting a manufacturing plan of the product for the first period based on the change in proficiency.

2. The manufacturing plan formulation method of claim 1, wherein:
the arithmetic circuit is accessible to a manufacturing result database including a plurality of pieces of manufacturing result data;
each of the plurality of pieces of manufacturing result data includes required-time data indicating a change in required time of the manufacturing process due to replacement of the plurality of actors, and a second indicator value indicating a degree of the replacement of the plurality of actors; and
the change in proficiency is identified based on required-time data included in manufacturing result data that is one of the plurality of pieces of manufacturing result data and includes a second indicator value corresponding to the first indicator value.

3. The manufacturing plan formulation method of claim 2, wherein the change in proficiency is determined based on: a length of a learning interval from replacement of the plurality of actors until required time reaches reference time in the required-time data; and a representative value of required time within the learning interval in the required-time data.

4. The manufacturing plan formulation method of claim 3, wherein the representative value is a maximum value.

5. The manufacturing plan formulation method of claim 2, wherein among second indicator values of the plurality of pieces of manufacturing result data, a second indicator value having a smallest difference from the first indicator value is determined to correspond to the first indicator value.

6. The manufacturing plan formulation method of claim 1, wherein:
the arithmetic circuit is accessible to a trained model;
the trained model includes one or more trained parameters generated by machine learning using a training dataset, and an inference program in which the one or more trained parameters are incorporated;
the training dataset includes, as input, the first indicator value and elapsed time since the start of the first period, and includes, as output, an indicator of proficiency; and
the arithmetic circuit is configured to identify the change in proficiency by using the trained model.

7. The manufacturing plan formulation method of claim 1, wherein the manufacturing plan includes a scheduled quantity of the product to be manufactured during the first period.

8. The manufacturing plan formulation method of claim 7, wherein the manufacturing plan includes a target quantity of the product to be manufactured during the first period.

9. The manufacturing plan formulation method of claim 8, wherein the scheduled quantity is determined based on a working period used for manufacturing the product during the first period and the change in proficiency.

10. The manufacturing plan formulation method of claim 9, wherein:
the manufacturing plan includes a production quantity of the products for each of a plurality of unit periods arranged in chronological order in the first period; and
in each of the plurality of unit periods, the production quantity is given by a sub working period at the unit period in the working period and proficiency at the unit period obtained from the change in proficiency.

11. The manufacturing plan formulation method of claim 7, wherein the manufacturing plan includes a sales amount of the product based on the scheduled quantity.

12. The manufacturing plan formulation method of claim 9, wherein:
the working period is a sum of a first working period that is a fixed value, and a second working period that is a variable value; and
the first working period and the second working period are identified separately.

13. The manufacturing plan formulation method of claim 12, wherein:
the scheduled quantity includes a first scheduled quantity corresponding to the first working period and a second scheduled quantity corresponding to the second working period; and
the manufacturing plan includes a manufacturing cost of the products based on the second working period and a sales amount of the products based on the second scheduled quantity.

14. A manufacturing plan formulation system for formulating a manufacturing plan for a product to be manufactured by a manufacturing process in which a plurality of actors perform tasks sequentially, comprising a first arithmetic circuit,
the first arithmetic circuit being configured to:
identify a first indicator value indicating a degree of replacement of the plurality of actors during a first period;
identify, based on the first indicator value, a change in proficiency of the plurality of actors from a start of the first period; and
output a manufacturing plan of the product for the first period based on the change in proficiency.

15. A non-transitory storage medium storing a program for enabling the manufacturing plan formulation method of claim 1 to be performed by the arithmetic circuit.

16. An information terminal to be communicably connected to the manufacturing plan formulation system of claim 14, comprising:
an input device;
an output device;
a communication device; and
a second arithmetic circuit configured to control the input device, the output device, and the communication device,
the second arithmetic circuit being configured to:
receive, by the input device, input of the first indicator value;
send, by the communication device, the first indicator value to the manufacturing plan formulation system to receive the manufacturing plan from the manufacturing plan formulation system; and
present, by the output device, the manufacturing plan.
